(19) United States
(12) Patent Application Publication
(10) Pub. No.: US 2003/0220963 A1
(43) Pub. Date: Nov. 27, 2003

(54) System and method for converting data structures

(76) Inventors: Eugene Golovinsky, Houston, TX (US); Mark Sterin, Missouri City, TX (US)

Correspondence Address: WONG, CABELLO, LUTSCH, RUTHERFORD & BRUCCULERI,, P.C., 20333 SH 249, SUITE 600, HOUSTON, TX, 77070, US

(21) Appl. No.: 10/152,947

(22) Filed: May 21, 2002

(51) Int. Cl. G06F 15/16

(52) U.S. Cl. 709/203

(57) ABSTRACT

An improved method and system for converting data structures. A definition (e.g., a management information base definition) may be read. The definition may include definition objects. A mapping of the definition objects to a second set of objects may be created. The second set of objects may be common object system (COS) objects. A structure of information to be acquired from one or more agents may be determined, in response to reading the definition. The structure of the information may be metadata. The one or more agents may be simple network management protocol agents, or other types of agents, as desired. Information may be acquired from the one or more agents, in response to determining the structure of the information. At least a subset of the second set of objects may be created, using the acquired information and the mapping. The second set of objects may be accessed.

### BACKGROUND OF THE INVENTION

1. Field of the Invention

The present invention relates to computer software, and more particularly to a system and method for converting data structures.

2. Description of the Related Art

The data processing resources of business organizations are increasingly taking the form of a distributed computing environment in which data and processing are dispersed over a network comprising many interconnected, heterogeneous, geographically remote computers. Such a computing environment is commonly referred to as an enterprise computing environment, or simply an enterprise. As used herein, an “enterprise” refers to a network comprising two or more computer systems. Managers of an enterprise often employ software packages known as enterprise management systems to monitor, analyze, and manage the resources of the enterprise. For example, an enterprise management system might include a software agent on an individual computer system for the monitoring of particular resources such as CPU usage or disk access. The agent software may comprise one or more knowledge modules which are configurable to monitor or capture data from one or more of the computer systems and/or their subsystems. As used herein, an “agent,” “agent application,” or “software agent” is a computer program that is configured to monitor and/or manage the hardware and/or software resources of one or more computer systems. U.S. Pat. No. 5,655,081 discloses one example of an agent-based enterprise management system. As used herein, a “knowledge module” (“KM”) is a software component that is configured to monitor a particular system or subsystem of a computer system, network, or other resource.

An enterprise-wide namespace is one way to make data available throughout an enterprise. A namespace provides efficient referencing and retrieval of information. The term “namespace” generally refers to a set of names in which all names are unique. As used herein, a “namespace” may refer to a memory, or a plurality of memories which are coupled to one another, whose contents are uniquely addressable. “Uniquely addressable” refers to the property that items in a namespace have unique names such that any item in the namespace has a name different from the names of all other items in the namespace.

The Internet is one example of a namespace. The Internet comprises many individual computer systems which are linked together through an addressing system which guarantees that every server name is different from every other server name. The Internet achieves the property of unique addressability through the use of a hierarchical name structure. For example, the top level of the hierarchy includes a limited number of high-level domain suffixes such as “.com”, “.edu”, and “.org”. Within a high-level suffix such as “.com” are many domains such as, for example, “bmc.com”. The domain administrator of “bmc.com” has the ability to designate lower levels of the hierarchy, such as division names, subdivision names, site names, server names, and so on. For example, the unique name of an individual server may take a form such as “computer.site.division.bmc.com” or “computer.site.subdivision.division.bmc.com”. This hierarchy helps ensure that each server has a unique name within the namespace.

A namespace is typically a logical organization and not a physical one. The namespace of the Internet, for instance, is not related to physical interconnections. For instance, “server1.bmc.com” and “server2.bmc.com” could be physically located in the same room, in different countries, or anywhere in between. In other words, a namespace may be thought of as a plurality of distinct physical memories which are organized as a single, and possibly distributed, logical memory.

One approach towards organizing information or data in an enterprise is taken by the Web-Based Enterprise Management (WBEM) initiative, managed by the Desktop Management Task Force (DMTF). The WBEM initiative is intended to prescribe enterprise management standards. One WBEM standard, the Common Information Model (CIM), is a platform-independent, object-oriented information model which allows for the interchange of management information between management systems and applications. CIM offers a single data-description mechanism for enterprise data sources from multiple vendors and frameworks. CIM provides a Meta Schema and a Schema. The CIM Meta Schema is a formal definition of the information model: it defines the terms used to express the model and the usage and semantics of the terms. The CIM Meta Schema also supports associations as types of classes. The CIM Schema provides the actual model descriptions. In other words, the CIM Schema supplies a set of classes with properties and associations that provide a conceptual framework for organizing the available information about a managed environment in an enterprise. Nevertheless, the Common Information Model merely provides the basic functionality to allow products from different vendors to exchange management data with one another; vendors must usually provide extensions (e.g., code generation) to CIM in order to support product development. Furthermore, CIM does not specify how to implement its data description model in an enterprise-wide namespace.

Due to differences in implementation of the structure or pre-defined form of data by various vendors and/or various standards, exchanging data between vendors and/or applications typically requires some type of conversion. One example of the need to exchange data between vendors is when a new system is being installed and data from a legacy system needs to be migrated to the new system. Conversion code generation is a common method for supporting this exchange of data from the legacy system to the new system. Conversion code generation is typically a time-consuming, error-prone, one-time endeavor, requiring significant resources (e.g., equipment, personnel). Conversion code accesses or reads data in one form (e.g., the form existing in the legacy system), then converts the data to a second form (e.g., the form required in the new system).

Requiring the user to generate code in order to exchange management data and/or convert data structures presents a need for skilled users capable of writing the required code. It is desirable to be able to convert data structures without the need for skilled users capable of writing computer programs.

For the foregoing reasons, there is a need for a system and method for converting data structures without requiring code generation.

### SUMMARY OF THE INVENTION

The present invention provides various embodiments of an improved method and system for converting data structures.

In one embodiment, the method operates as follows. First, a definition (e.g., a management information base (MIB) definition) may be read. The definition may include objects (e.g., definition objects). In the case of a MIB definition, the definition objects may be determined by a portion of the MIB loaded into the system. Next, a mapping of the definition objects to a second set of objects may be created. The second set of objects may be common object system (COS) objects.

In one embodiment, the definition objects may be organized in tables and the second set of objects may be organized by hierarchical namespace with naming conventions to ensure uniqueness of object names for the given level in the hierarchy. The namespace may be exported through a network management system (e.g., SNMP). The namespace exporting may be “bi-directional” (e.g, SNMP to COS and vice versa). It is noted that any namespace may be exported in this manner.

A structure of information to be acquired from one or more agents may be determined, in response to reading the definition. The structure of the information may include metadata. The one or more agents may be simple network management protocol agents, or other types of agents, as desired. Information may be acquired from the one or more agents, in response to determining the structure of the information.

At least a subset of the second set of objects may be created, using the acquired information and the mapping. In one embodiment, while there are objects remaining to be processed, additional objects of the second set of objects may be created.

The procedure of creating the second set of objects may be data driven. For example, if the acquired information from one or more agents includes interfaces of one or more computer systems, then the second set of objects that are created would include a like number of “interface” type objects. Each computer system may report its own interfaces.

The second set of objects may be accessed interactively by any program for the purpose of obtaining information. The accessing program therefore does not directly access the definition objects, but rather only accesses the second set of objects.

### BRIEF DESCRIPTION OF THE DRAWINGS

A better understanding of the present invention can be obtained when the following detailed description of various embodiments is considered in conjunction with the following drawings, in which:

FIG. 1 illustrates an exemplary first computer system according to one embodiment of the present invention;

FIG. 2 illustrates an enterprise computing environment according to one embodiment of the present invention; and

FIG. 3 is a flowchart describing converting data structures according to one embodiment of the present invention.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims.

### DETAILED DESCRIPTION OF SEVERAL EMBODIMENTS

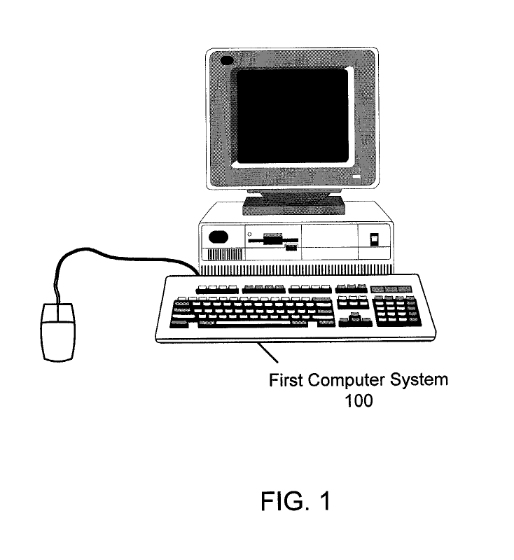

FIG. 1—First Computer System

FIG. 1 illustrates a first computer system 100 operable to execute conversion of data structures. Various embodiments of systems and methods of converting data structures are described below. The first computer system 100 may be any type of computer system, including a personal computer system, mainframe computer system, workstation, network appliance, Internet appliance, personal digital assistant (PDA), television system or other device. In general, the term “computer system” may be broadly defined to encompass any device having at least one processor that executes instructions from a memory medium.

As shown in FIG. 1, the first computer system 100 may include a display device operable to display operations associated with the data structure conversion process. The display device may also be operable to display a graphical user interface for use in the data structure conversion process. The graphical user interface may comprise any type of graphical user interface, e.g., depending on the computing platform.

The first computer system 100 may include a memory medium(s) on which one or more computer programs or software components according to one embodiment of the present invention may be stored. For example, the memory medium may store one or more data structure conversion software programs which are executable to perform the methods described herein. Also, the memory medium may store a programming development environment application used to create and/or execute data structure conversion software programs. The memory medium may also store operating system software, as well as other software for operation of the computer system.

The term “memory medium” is intended to include various types of memory or storage, including an installation medium, e.g., a CD-ROM, floppy disks, or tape device; a computer system memory or random access memory such as DRAM, SRAM, EDO RAM, Rambus RAM, etc.; or a non-volatile memory such as a magnetic media, e.g., a hard drive, or optical storage. The memory medium may comprise other types of memory or storage as well, or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer system for execution.

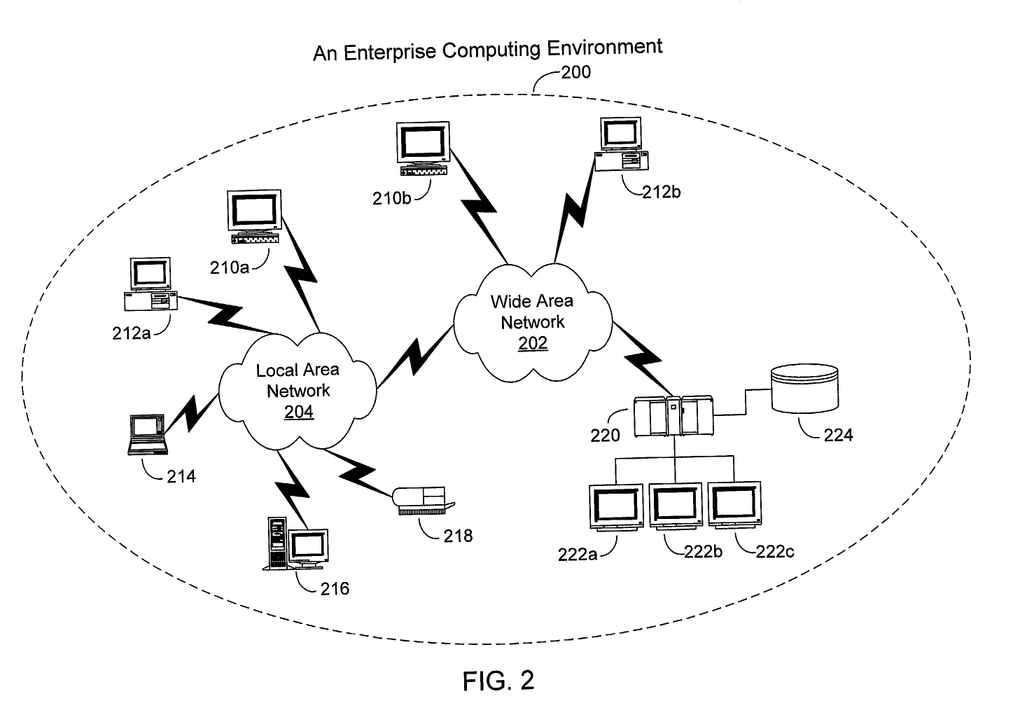

FIG. 2—A Typical Enterprise Computing Environment

FIG. 2 illustrates an enterprise computing environment 200 according to one embodiment of the present invention. An enterprise 200 may include a plurality of computer systems such as first computer system 100 which are interconnected through one or more networks. Although one particular embodiment is shown in FIG. 2, the enterprise 200 may comprise a variety of heterogeneous computer systems and networks which are interconnected in a variety of ways and which run a variety of software applications.

One or more local area networks (LANs) 204 may be included in the enterprise 200. A LAN 204 is a network that spans a relatively small area. Typically, a LAN 204 is confined to a single building or group of buildings. Each node (i.e., individual computer system or device) on a LAN 204 preferably has its own CPU with which it executes computer programs, and often each node is also able to access data and devices anywhere on the LAN 204. The LAN 204 thus allows many users to share devices (e.g., printers) as well as data stored on file servers. The LAN 204 may be characterized by any of a variety of types of topology (i.e., the geometric arrangement of devices on the network), of protocols (i.e., the rules and encoding specifications for sending data, and whether the network uses a peer-to-peer or client/server architecture), and of media (e.g., twisted-pair wire, coaxial cables, fiber optic cables, radio waves). FIG. 2 illustrates an enterprise 200 including one LAN 204. However, the enterprise 200 may include a plurality of LANs 204 which are coupled to one another through a wide area network (WAN) 202. A WAN 202 is a network that spans a relatively large geographical area.

Each LAN 204 may include a plurality of interconnected computer systems or at least one computer system and at least one other device. Computer systems and devices which may be interconnected through the LAN 204 may include, for example, one or more of a workstation 210a, a personal computer 212a, a laptop or notebook computer system 214, a server computer system 216, or a network printer 218. An example LAN 204 illustrated in FIG. 2 includes one of each of these computer systems 210a, 212a, 214, and 216 and one printer 218. Each of the computer systems 210a, 212a, 214, and 216 is preferably an example of the typical computer system 100 as illustrated in FIG. 1. The LAN 204 may be coupled to other computer systems and/or other devices and/or other LANs 204 through a WAN 202.

A mainframe computer system 220 may optionally be coupled to the enterprise 200. As shown in FIG. 2, the mainframe 220 is coupled to the enterprise 200 through the WAN 202, but alternatively the mainframe 220 may be coupled to the enterprise 200 through a LAN 204. As shown in FIG. 2, the mainframe 220 is coupled to a storage device or file server 224 and mainframe terminals 222a, 222b, and 222c. The mainframe terminals 222a, 222b, and 222c access data stored in the storage device or file server 224 coupled to or comprised in the mainframe computer system 220.

The enterprise 200 may also include one or more computer systems which are connected to the enterprise 200 through the WAN 202: as illustrated, a workstation 210b and a personal computer 212b. In other words, the enterprise 200 may optionally include one or more computer systems which are not coupled to the enterprise 200 through a LAN 204. For example, the enterprise 200 may include computer systems which are geographically remote and connected to the enterprise 200 through the Internet.

Typically, each computer system in the enterprise 200 executes or runs a plurality of software applications or processes (e.g., data structure conversion software programs). Each software application or process consumes a portion of the resources of a computer system and/or network: for example, CPU time, system memory such as RAM, nonvolatile memory such as a hard disk, network bandwidth, and input/output (I/O).

Each of the computer systems in FIG. 2 may include various standard components such as one or more processors or central processing units (CPUs) and one or more memory media, and other standard components, e.g., a display device, input devices, a power supply, etc. Each of the computer systems in FIG. 2 may also be implemented as two or more different computer systems.

At least one of the computer systems in FIG. 2 preferably includes a memory medium on which computer programs are stored. Also, the computer systems in FIG. 2 may be any type of computer system, including a personal computer system, mainframe computer system, workstation, network appliance, Internet appliance, personal digital assistant (PDA), television system or other device.

The memory medium may store one or more software programs for implementing the data structure conversion process. The software programs may be implemented in any of various ways, including procedure-based techniques, component-based techniques, and/or object-oriented techniques, among others. For example, the software programs may be implemented using C++ objects, Java objects, Microsoft Foundation Classes (MFC), or other technologies or methodologies, as desired. A CPU of one of the computer systems shown in FIG. 2 executing code and data from the memory medium comprises a means for implementing the data structure conversion process according to the methods or flowcharts described below.

Various embodiments further include receiving or storing instructions and/or data implemented in accordance with the foregoing description upon a carrier medium. Suitable carrier media include memory media or storage media such as magnetic or optical media, e.g., disk or CD-ROM, as well as signals such as electrical, electromagnetic, or digital signals, conveyed via a communication medium such as networks and/or a wireless link.

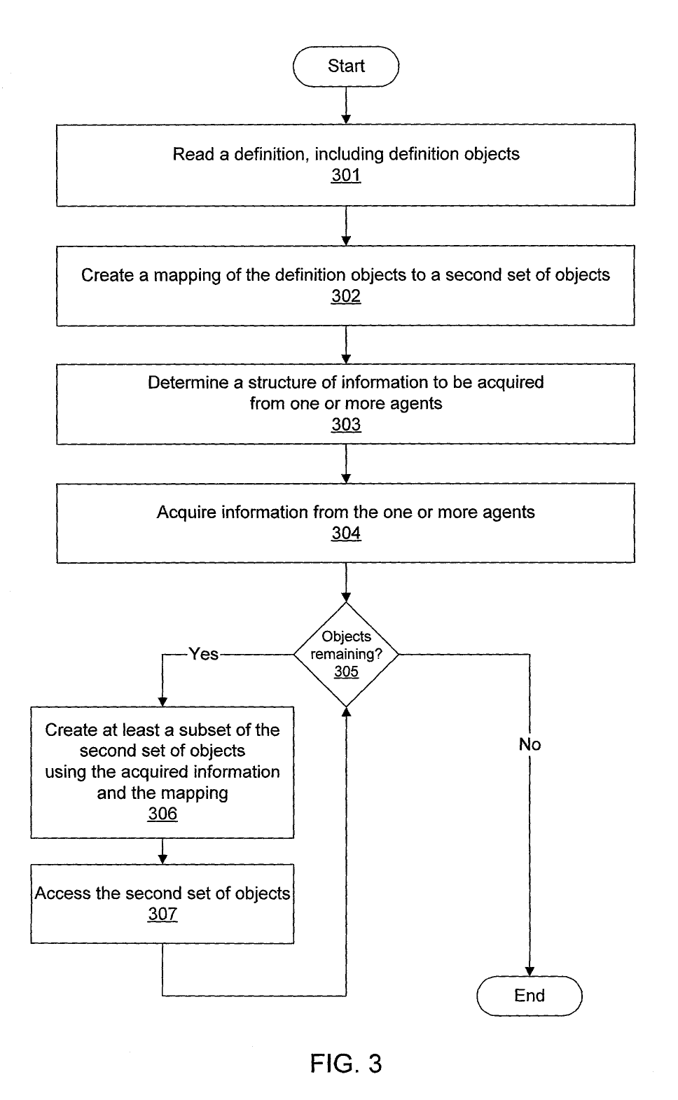

FIG. 3—Converting Data Structures

FIG. 3 is a flowchart of an embodiment of a system and method for converting data structures.

In step 301, a definition may be read. The definition may include objects. The definition may be a management information base (MIB) definition. As used herein, a “MIB” (Management Information Base) is a formal description of a set of network objects (e.g., a database of objects) that may be managed and/or monitored by a network management system (e.g., SNMP). SNMP uses standardized MIB formats that allows any SNMP tools to monitor any device defined by a MIB. In the case of a MIB definition, the definition objects may be determined by a portion of the MIB loaded into the system.

In step 302, a mapping of the definition objects to a second set of objects may be created. The second set of objects may be common object system (COS) objects. COS objects are explained in more detail below. In one embodiment, the definition objects may be organized in tables and the second set of objects may be organized by hierarchical namespace with naming conventions to ensure uniqueness of object names for the given level in the hierarchy. The namespace may be exported through a network management system (e.g., SNMP). The namespace exporting may be “bi-directional” (e.g, SNMP to COS and vice versa). It is noted that any namespace may be exported in this manner.

In step 303, a structure of information to be acquired from one or more agents may be determined. The structure of information to be acquired may be determined based on the definition read in step 301.

The structure of the information may include metadata. As used herein, metadata is formatted information describing how, when, and by whom a particular set of data was collected, and how the particular set of data is formatted. The one or more agents may be simple network management protocol agents, or other types of agents, as desired.

As background for the following example, some terms need to be defined. The Internet Engineering Task Force (IETF) is the main standards organization for the Internet. RFC refers to “Request for Comments”. RFCs published by the IETF are series of notes about the Internet. Input for new and/or not-yet-published RFCs may be sent by any interested party to the IETF. The IETF periodically reviews input for RFCs, and makes the decision as to whether the input warrants inclusion in a not-yet-published RFC or creation of a new RFC. When a published RFC gains enough interest, it may evolve into an Internet standard. Each published RFC is designated by an RFC number (e.g., RFC 1213, RFC 1493, see below for more details). Once published, an RFC never changes. Modifications to an original RFC are assigned a new RFC number.

The example below refers to two RFCs or documents related to MIB that are published by the IETF: RFC 1213 known as Internet standard MIB-II and RFC 1493 known as Internet standard Bridge MIB. The Internet standards MIB-II and Bridge MIB are commonly referred to as MIB definitions. A target agent may or may not carry information related to these MIB definitions. Once these MIB definitions are loaded into a system, the system may attempt to contact target agents to discover if these target agents carry information in accordance with these MIB definitions.

For example, consider two target agents: the first target agent running on an HP server and the second target agent running on a Cisco switch. In this case, the HP server may report support for the MIB-II standard only whereas the Cisco switch may report support for both the MIB-II standard and the Bridge MIB standard. Thus, a hypothetical namespace for the first target agent may include: HP_server/MIB-II/IF_Entry. Similarly, a hypothetical namespace for the second target agent may include: Cisco_SW/MIB-II/IF_Entry and Cisco_SW/BRIDGE-MIB/dot1dTpPortTable_Entry. In this example, the name “HP_server/MIB-II/IF_Entry” corresponds to the MIB definition of Interface table entry which is defined as “1.3.6.1.2.1.2.2.1” on HP_server. The very same MIB definition on Cisco_SW is referred to as: “Cisco_SW/MIB-II/IF_Entry” simply because it runs on a separate target agent. It is noted that since HP_server does not support the Bridge MIB standard, no “BRIDGE-MIB” entries were discovered, and therefore no “BRIDGE-MIB” namespace entries were created in the namespace for HP_server.

In step 304, information from the one or more agents may be acquired. The acquired information may be according to the structure of the information determined in step 303. Examples of types of information that may be acquired may include: network interfaces (e.g., LAN/WAN) of a computer system; properties of the network interfaces (e.g., type (Ethernet, FDDI, Token Ring, among others), admin status (e.g., up/down), speed); software processes running on the computer system; availability and/or types of storage/memory sub-systems of the computer system; any information (e.g., management related information) that the computer system may export in accordance with the defined structure of the information.

Step 305 is a decision step. In step 305, a check is made as to whether more objects (i.e., definition objects) remain to be processed. If a definition object remains to be processed, then processing continues with step 306; otherwise processing completes.

In step 306, at least a subset of the second set of objects may be created using the acquired information and the mapping. In one embodiment, the procedure of creating the second set of objects may be data driven. For example, if the acquired information from one or more agents includes interfaces of one or more computer systems, then the second set of objects that are created would include a like number of “interface” type objects. Each computer system may report its own interfaces. Thus, in a case of three computer systems where System1 has two interfaces, System2 has three interfaces, and System3 has only one interface, the “interface” type objects may be referred to as follows: System1/interface1, System1/interface2, System2/interface1, System2/interface2, System2/interface3, System3/interface1.

In step 307, the second set of objects may be accessed. Typically, this is an interactive process. Once an object in the second set of objects has been created in the previous step, any program may access the newly created object of the second set of objects to obtain information. The accessing program therefore does not directly access the definition objects, but rather only accesses the second set of objects. Processing loops back to decision step 305. It is noted that the accessing of the second set of objects and the looping back to decision step 305 may be done in parallel. Further, if no program requests access to the second set of objects, processing may still loop back to decision step 305.

Information or data in an enterprise may be organized using the Common Object System (COS), a component of the PATROL product of BMC Software, Inc. The COS is an object management system that provides a consistent methodology for creating, accessing, and manipulating data objects across the PATROL architecture. Central to COS is the COS namespace, which is a virtual data repository that resides on each server containing a PATROL agent. The data is normalized into a rigidly defined schema or format and made available both locally and remotely. Each level of the hierarchy (e.g., managed system, domain level, enterprise level) has a namespace, and the objects managed by each level may vary in scope; however, because references are made logically, the functions that access COS objects do not need to know the physical location of those objects.

COS is both an object model and an Application Program Interface (API) providing interfaces to store and present data in the namespaces. COS APIs allow KMs and COS back-ends to invoke services and to access data in namespaces. COS back-ends may be reusable, thus allowing reuse of common functions. In addition, the agent provides an API that may develop COS adapters. These COS adapters may be used to bring into the namespace data that does not originate from a KM, but rather data brought into the namespace through XML (Extensible Markup Language), SNMP (Simple Network Management Protocol), CORBA (Common Object Request Broker Architecture) and so on.

Although the system and method of the present invention have been described in connection with several embodiments, the invention is not intended to be limited to the specific forms set forth herein, but on the contrary, it is intended to cover such alternatives, modifications, and equivalents as can be reasonably included within the spirit and scope of the invention as defined by the appended claims.

What is claimed is:

1. A computer-implemented method of converting data structures, the method comprising:
reading a definition wherein the definition comprises definition objects;
creating a mapping of the definition objects to a second set of objects;
determining a structure of information to be acquired from one or more agents in response to reading the definition;
acquiring information from the one or more agents in response to determining the structure of the information;
creating at least a subset of the second set of objects using the acquired information and the mapping.

2. The method of claim 1, further comprising accessing the second set of objects.

3. The method of claim 1, wherein the definition comprises a management information base definition.

4. The method of claim 1, wherein the structure of the information comprises metadata.

5. The method of claim 1, wherein the second set of objects comprise common object system objects.

6. The method of claim 1, wherein the one or more agents comprise simple network management protocol agents.

7. A system of converting data structures, the system comprising:
a network;
a CPU coupled to the network;
a system memory coupled to the CPU, wherein the system memory stores one or more computer programs executable by the CPU;
wherein the computer programs are executable to:
read a definition wherein the definition comprises definition objects;
create a mapping of the definition objects to a second set of objects;
determine a structure of information to be acquired from one or more agents in response to reading the definition;
acquire information from the one or more agents in response to determining the structure of the information;
create at least a subset of the second set of objects using the acquired information and the mapping.

8. The system of claim 7, wherein the computer programs are further executable to access the second set of objects.

9. The system of claim 7, wherein the definition comprises a management information base definition.

10. The system of claim 7, wherein the structure of the information comprises metadata.

11. The system of claim 7, wherein the second set of objects comprise common object system objects.

12. The system of claim 7, wherein the one or more agents comprise simple network management protocol agents.

13. A carrier medium which stores program instructions, wherein the program instructions are executable to implement:
reading a definition wherein the definition comprises definition objects;
creating a mapping of the definition objects to a second set of objects;
determining a structure of information to be acquired from one or more agents in response to reading the definition;
acquiring information from the one or more agents in response to determining the structure of the information;
creating at least a subset of the second set of objects using the acquired information and the mapping.

14. The carrier medium of claim 13, wherein the program instructions are further executable to implement accessing the second set of objects.

15. The carrier medium of claim 13, wherein the definition comprises a management information base definition.

16. The carrier medium of claim 13, wherein the structure of the information comprises metadata.

17. The carrier medium of claim 13, wherein the second set of objects comprise common object system objects.

18. The carrier medium of claim 13, wherein the one or more agents comprise simple network management protocol agents.

19. The carrier medium of claim 13, wherein the carrier medium is a memory medium.
